(19) United States
(12) Patent Application Publication
(10) Pub. No.: US 2006/0068184 A1
(43) Pub. Date: Mar. 30, 2006

(54) Polyimide film and polyimide composite sheet

(75) Inventors: Kazuyuki Hamada, Yamaguchi (JP); Takashi Amane, Yamaguchi (JP); Yasuhiro Nagoshi, Yamaguchi (JP); Kazuhiro Fujiwara, Yamaguchi (JP); Kiyotaka Kobayashi, Yamaguchi (JP); Taei Uchida, Yamaguchi (JP); Norihisa Komoda, Yamaguchi (JP)

Correspondence Address: NIXON PEABODY, LLP, 401 9TH STREET, NW, SUITE 900, WASHINGTON, DC, 20004-2128, US

(73) Assignee: Ube Industries, Ltd., Ube-shi (JP)

(21) Appl. No.: 11/237,731

(22) Filed: Sep. 29, 2005

(30) Foreign Application Priority Data
Sep. 29, 2004 (JP) 2004-283665

(51) Int. Cl. B32B 27/32

(52) U.S. Cl. 428/220

(57) ABSTRACT

An aromatic polyimide film favorably employable for the chip-on-film (COF) system is composed of a polyimide derived from 3,3′,4,4′-biphenyltetracarboxylic acid dianhydride and p-phenylenediamine and a powdery inorganic filler, in which the film has a thickness in the range of 25 to 35 μm and does not have protrusions of 1 μm or higher, and the filler has a mean diameter of less than 1 μm.

### FIELD OF THE INVENTION

The present invention relates to a polyimide film and a polyimide composite sheet which are favorably employable for packaging electronic chips according to a known chip on film (COF) system.

### BACKGROUND OF THE INVENTION

An aromatic polyimide film has excellent characteristics in its heat resistance, mechanical strength, electric properties, resistance to alkali and acid, and flame resistance, and hence is widely utilized, for instance, to produce a copper-clad laminate for packaging electronic components on a film according to tape-automated bonding (TAB). For TAB system, an aromatic polyimide film having a thickness of 75 μm has been generally employed. Recently, an aromatic polyimide film having a thickness of 50 μm has been studied for the use in a system according to TAB.

U.S. Pat. No. 6,217,996B1 describes an aromatic polyimide film favorably employable for packaging electronic components on a film according to (TAB). The aromatic polyimide film has a thickness of 5 to 150 μm and comprises polyimide derived from a biphenyltetracarboxylic acid compound and a phenylenediamine compound. The aromatic polyimide film may contain an inorganic filler having a particle size in the range of 0.005 to 0.3 μm.

Recently, it has been tried to use an aromatic polyimide film for a system of packaging electronic chip on film (COF). A typical commercially available aromatic polyimide film for COF system comprises polyimide derived from a pyromellitic acid compound and a diamine compound, has a thickness of approx. 40 μm, and contains an inorganic filler having a particle size of more than 1 μm.

It has been found that the commercially available aromatic polyimide film for COF system has the following drawbacks:

(1) the polyimide film has protrusions of larger than 1 μm, and a polyimide composite sheet comprising the polyimide film and a copper film deposited on the polyimide film is liable-to have large protrusions on the copper film; therefore it is not favorably employed for forming a fine wiring pattern on the copper film; and

(2) a polyimide film on which bare electronic chips are mounted according to COF system is sometimes installed into an electric apparatus after bending in a U-shape, and the polyimide film is highly resistant to the bending and is sometimes not well installed into an electronic apparatus.

### SUMMARY OF THE INVENTION

It is an object of the present invention to provide an aromatic polyimide film and a polyimide composite sheet which are favorably employable for packaging electronic chips according to a known chip on film (COF) system.

The present invention resides in an aromatic polyimide film comprising a polyimide derived from 3,3′,4,4′-biphenyltetracarboxylic acid dianhydride and p-phenylenediamine and a powdery inorganic filler, in which the film has a thickness in the range of 25 to 35 μm and does not have protrusions of 1 μm or higher, and the filler has a mean diameter of less than 1 μm.

The invention also resides in a polyimide composite sheet comprising an aromatic polyimide film of the invention and a metal layer deposited on the polyimide film, in which the metal film comprises a copper over-coat film and a under-coat layer comprising at least one metal other than copper.

The invention further resides in a process packaging a bare chip on film, which comprises the steps of:

forming a wiring pattern on a polyimide composite sheet of the invention; and

bonding the bare chip to the wiring pattern on the polyimide composite sheet.

### BRIEF DESCRIPTION OF THE DRAWINGS

FIG. 1 is a profile of the surface condition of the polyimide film of Example 1 obtained by three-dimensional non-contact surface condition observation system (sampling skip value: 1, cut off value: λc=0.08 mm).

FIG. 2 is a profile of the surface condition of the commercially available polyimide film of Comparison Example 2 obtained by the same observation system.

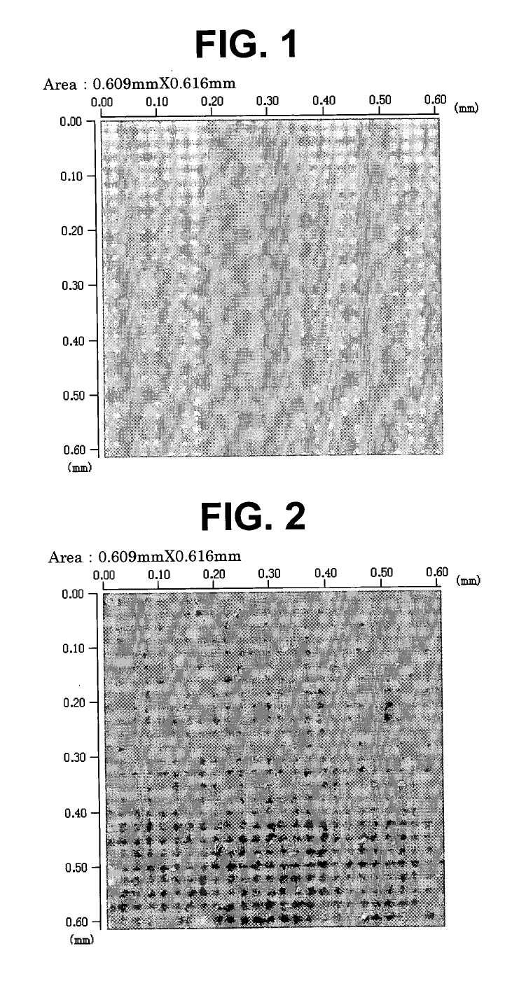

### DETAILED DESCRIPTION OF THE INVENTION

Preferred embodiments of the inventions are described below;

(1) the polyimide is derived from 3,3′,4,4′-biphenyltetracarboxylic acid dianhydride and p-phenylenediamine in the presence of a phosphoric compound;

(2) the thickness of the film-varies within 1 μm in a width direction of the film;

(3) the thickness of the polyimide film is in the range of 30 to 35 μm.

(4) the thickness of the film varies within 0.7 μm in a width direction of the film;

(5) the mean diameter of the powdery inorganic filler is in the range of 0.005 to 0.3 μm;

(6) the powdery inorganic filler is contained in an amount of 0.1 to 3 wt. % based on the amount of the polyimide;

(7) the aromatic polyimide film has defective spots of not more than 15/m² on a surface thereof;

(8) the aromatic polyimide film has a surface coated with a silane coupling agent;

(9) the aromatic polyimide film has a coefficient of linear thermal expansion in the range of 10×10⁻⁶ to 17×10⁻⁶ cm/cm/° C. in each of a machine direction thereof and a transverse direction thereof;

(10) the aromatic polyimide film of claim 1, which has a spring back value of 1.5 g or less, preferably in the range of 0.75 g to 1.5 g;

(11) the aromatic polyimide film has been subjected to electrical discharge processing in vacuo;

(12) the under-coat layer of the polyimide composite sheet comprises Al, W, Fe, Ni—Cr alloy, or Mo—Ni alloy.

(13) the aromatic polyimide film has a mean waviness length of 10 nm or lower, preferably 1 nm or lower;

(14) the-aromatic polyimide film has a root square waviness length of 10 nm or lower, preferably in the range of 0.1 to 10 nm, more preferably 0.1 to 1 nm.

(15) the aromatic polyimide film has a maximum protrusion height of 1,000 nm (1 μm) or lower, preferably 1 to 1,000 nm, more preferably 1 to 300 nm, most preferably 1 to 30 nm.

In the specification, the coefficient of linear thermal expansion, the spring back value, and the waviness length were a coefficient, a value, and a waviness length determined by the following methods.

(i) Coefficient of Linear Thermal Expansion

An aromatic polyimide film sample is heated at 300° C. for 30 minutes for stress relaxation and then set to TMA apparatus and extended at temperatures from 50 to 200° C. (extension mode, weight 2 g, sample length 10 mm, 20° C./min.)

(ii) Spring Back Value

One end of an aromatic polyimide film sample (10 mm (width)×70 mm (length)) is combined to another end using an adhesive plastic tape to produce a cylindrical specimen. The cylindrical specimen is placed on a glass plate under the condition that the combined area of the film sample is temporarily fixed onto the glass plate via an adhesive. The glass plate is then placed on a spring balance. On the top of the fixed cylindrical specimen is placed a metal plate mounted to poles. The metal plate is placed above the glass plate with a space of approx. 19 mm. The cylindrical specimen is kept for one minute under the condition, and then a spring-back ability is measured in term of a weight received by the spring balance.

(iii) Waviness Length

The section curve of surface of the film is processed by profile filter (cut off value λc: 0.08 mm) to determine the waviness length.

The present invention is further described below.

The aromatic polyimide film of the invention comprises polyimide derived from 3,3′,4,4′-biphenyltetracarboxylic acid dianhydride and p-phenylenediamine. In the preparation of the polyimide, the 3,3′,4,4′-biphenyltetracarboxylic acid dianhydride can be employed together with a relatively small amount (less than 50 mol. %, preferably less than 25 mol. %) of other aromatic tetracarboxylic acid compounds such as 2,3,3′,4′-biphenyltetracarboxylic acid dianhydride or 3,3′,4,4′-benzophenonetetracarboxylic acid dianhydride. The p-phenylenediamine also can be employed together with a relative small amount (less than 50 mol. %, preferably less than 25 mol. %) of other aromatic diamines such as 4,4′-diaminodiphenyl ether, 4,4′-diaminodiphenylpropane, 4,4′-diaminodiphenylethane, 4,4′-diaminodiphenylmethane, bis[4-(4-aminophenoxy)phenyl]propane, 2,2′-bis[4-(aminophenoxy)phenyl]-1,1,1,3,3,3-hexafluoropropane, bis[4-(4-aminophenoxy)phenyl]ether, or o-tolidine.

In the-polyimide film, a small amount of a powdery inorganic filler is contained. The powdery inorganic filler ought to have a mean diameter of less than 1 μm, preferably in the range of 0.005 to 0.3 μm. The powdery inorganic filler preferably contains substantially no filler particle having a diameter of 1 μm or more.

The aromatic polyimide film of the invention can be prepared by the following process.

In an organic polar solvent such as N,N-dimethylacetamide or N-methyl-2-pyrrolidone, 3,3′,4,4′-biphenyltetracarboxylic acid dianhydride and p-phenylenediamine are reacted preferably at a temperature of 10 to 80° C. for 1 to 30 hours to give a polyamic acid solution containing 15 to 25 wt. % of a polyamic acid and a rotary viscosity (at 30° C.) in the range of 500 to 4,500 poises. The polyamic acid preferably shows an imidation ratio of not more than 5%, and a longitudinal viscosity (at 30° C., 0.5 g/100 mL of N-methyl-2-pyrrolidone) in the range of 1.5 to 5.

The polyamic acid is then converted into polyimide by imidation reaction. The imidation reaction is preferably performed in the presence of a phosphoric compound such as an organic phosphoric compound (e.g., polyphosphoric ester or an amine salt of phosphoric ester) or an inorganic phosphoric compound. The phosphoric compound is preferably employed in an amount of 0.01 to 2 weight parts per 100 weight parts of the polyamic acid.

In advance of performing the imidation reaction, a powdery inorganic filler is placed in the polyamic acid solution. The powdery inorganic filler ought to have a mean diameter of less than 1 μm, preferably in the range of 0.005 to 0.3 μm, more preferably in the range of 0.005 to 0.1 μm. Examples of the powdery inorganic fillers include colloidal silica, boron nitride powder, talc, and titan dioxide powder.

The polyamic acid solution containing the powdery inorganic fillers and the phosphoric compound then continuously cast on a metal belt to give a solution film having a thickness in the range of 200 to 300 μm. The cast film is then heated at 120 to 170° C. for 2 to 20 minutes, to give a self-supporting solid film having a volatile component content of 25 to 30 wt. %. The solid film is preferably coated with a silane-coupling agent. The silane coupling agents can be aminosilane compounds or epoxysilane compounds. Examples of the epoxysilane compounds include β-(3,4-epoxycyclohexyl)-ethyl-trimethoxysilane and γ-glycidoxypropyl-trimethoxysilane. Examples of the aminosilane compounds include γ-amino-propyl-triethoxysilane, N-β-(aminoethyl)-γ-aminopropyl-triethoxysilane, N-(aminocarbonyl)-γ-aminopropyl-triethoxysilane, N-[β-(phenylamino)ethyl]-γ-aminopropyl-triethoxysilane, and N-phenyl-γ-aminopropyl-triethoxysilane. The silane coupling agent is preferably employed in the form of a low viscosity solution containing the coupling agent in an amount of 0.5 to 60 wt. %. As the solvent, a lower alcohol or an amide solvent is employed. The solvent can be the same as that employed for the preparation of a polyamic acid. The lower alcohol can be methyl alcohol, ethyl alcohol, propyl alcohol, or butyl alcohol.

Subsequently, both sides of the self-supporting solid film are fixed to plural film grips mounted onto a pair of chains movable along rails, and the solid film is then introduced into a continuous heating furnace. In the furnace, the solid film is first dried to give a relatively dry film containing volatile components in a amount of 27 to 28 wt. %, and then heated to a maximum temperature in the range of 400 to 525° C., specifically 475 to 500° C., for 0.5 to 30 minutes so as to undergo imidation reaction resulting in giving a continuous aromatic polyimide film containing volatile components in an amount of less than 0.4 wt. %.

The aromatic polyimide film is preferably heated to 200 to 400° C. under no or low tension for stress relaxation, and wound to give an aromatic polyimide film roll. Thus produced aromatic polyimide film preferably has a thickness in the range of 25 to 35 μm, more preferably 30 to 35 μm and shows a coefficient of linear thermal expansion in the range of 10×10⁻⁶ to 17×10⁻⁶ cm/cm/° C. in each of the machine direction and transverse direction, and the coefficient of linear thermal expansion in the transverse direction is larger than the coefficient of linear thermal expansion in the machine direction by not larger than 5×10⁻⁶ cm/cm/° C. The aromatic polyimide film-preferably has a modulus in tension (in both of MD and TD directions) of 700 kgf/m² or higher, preferably in the range of 700 to 1,000 kgf/m².

The aromatic polyimide film produced in the above-mentioned way generally has defective spots in the form of a liquid drop only in a number of less than 15/1 mm², specifically 1 to 15/1 mm². The aromatic polyimide film having such little number of defective spots is favorably employable for the COF system.

It is preferred that the aromatic polyimide film is then subjected to electric discharge processing such as plasma processing in vacuo. The electric discharge processing can be applied to the polyimide film after the film is treated with an organic solvent such as acetone, isopropyl alcohol, or ethyl alcohol.

The electric discharge processing is preferably carried out in an oxygen-containing atmospheric gas at a pressure of 0.1 to 1,500 Pa for a period of 1 second to 10 minutes. The atmospheric gas preferably contains rare gas such as He, Ne, Ar or Xe in an amount of 20 mol. % or more. Ar is preferably employed. The rare gas-containing gas can contain CO₂, N₂, H₂ or H₂O.

On the aromatic polyimide film, a metal layer is deposited. The metal layer preferably comprises a copper over-coat film and a under-coat film comprising at least one metal other than copper. The copper over-coat film can be an over-coat film of other electroconductive metal. The under-coat can be deposited on the polyimide film by a deposition method such as vapor deposition or sputtering. The vapor deposition can be carried out at a pressure of 10⁻⁵ to 1 Pa and at a deposition rate of 5 to 500 nm/sec. The sputtering is preferably carried out by DC magnet sputtering. The DC magnet sputtering is preferably performed at a pressure of 0.1 to 1 Pa and a deposition rate of 0.05 to 50 nm/sec. The under-coat metal film has a thickness preferably in the range of 10 nm to 1 μm, more preferably in the range of 0.1 to 0.5 μm. The under-coat metal film can be made of plural metal films. The bottom metal film can have a thickness in the range of 0.01 to 10 nm.

The under-coat metal film can be made of Ni, Cr, Mo, Ti, Pa, Zn, Al, Sn, Co, Zr, Fe or W, or one of their alloys, or one of their alloys with Cu.

On the under-coat metal film, an electroconductive metal film (i.e., over-coat metal film) such as copper film is placed by plating. The over-coat metal film has a thickness preferably in the range of 1 to 20 μm, more preferably 5 to 20 μm. The plating can be carried out by non-electrolytic plating or electrolytic plating. The non-electrolytic plating and electrolytic plating can be employed in combination.

The present invention is further described by the following examples. In the examples, the physical characteristics of the polyimide films were determined by the following procedures (at 25° C., except for the case in which the temperature is specified):

(1) modulus in tension: determined according to ASTM D882 (MD, TD)

(2) strength of adhesion: determined on the copper-clad laminate by 90° peeling (stress rate: 50 mm/min.)

(3) defective spots on film surface: defective spots having a diameter (longest axis in the case of non-circular spot such as rectangular or oval) of 50 μm or more is counted under microscopic observation.

(4) surface conditions: the surface of copper over-coat is microscopically examined; the marks are given according to the following criteria:

good: no large concaves and convexes are present;

bad: large concaves and convexes are present.

(5) thickness variation
the film thickness of a film strip sample (length: 50 mm) is measured at every 30 mm points from the center point for both of MD and TD direction by means of a thickness meter (MILLITRON available from Fine Proof Corp.).

(6) smoothness

the film surface is scanned by a surface condition-measuring apparatus (MM520ME-M100, available from Ryoka System Co., Ltd.) according to three-dimensional non-contact surface condition-measuring system, to determine a mean waviness length, a mean square root waviness length, and a maximum protrusion height.

### COMPARISON EXAMPLE 1

A polyamic acid solution (solvent: N,N-dimethylacetamide, concentration: 18 wt. %, solution viscosity at 30° C.: 1,800 poises, logarithmic viscosity of the polyamic acid solution (0.5 g/100 mL in N,N-dimethylacetamide) at 30° C.: 1.8,) was prepared from 3,3′,4,4′-biphenyltetracarboxylic carboxylic acid dianhydride and p-phenylenediamine. To the polyamic acid solution was added triethanolamine salt of monostearyl phosphoric acid ester in an amount of 0.1 weight part and a colloidal silica (ST-ZL, available from Nissan Chemical Industries, Co., Ltd., mean diameter: 0.08 μm) in an amount of 0.5 weight part, per 100 weight parts of the polyamic acid. The polyamic acid solution was then cast on a stainless substrate and heated to give a self-supporting dry polyamic acid film (thickness: 50 μm). The dry polyamic acid film was separated from the substrate was heated to a temperature elevating from 140° C. to 450° C. in a furnace to remove the solvent and proceed with imidization. Thus, an aromatic polyimide film (thickness: 50 μm) was prepared.

Three pieces of the aromatic polyimide films were subjected to the determination of spring back value. A mean spring back value was 2.99 g.

### EXAMPLE 1

To a polyamic acid solution prepared in the same manner as in Comparison Example 1 were added 0.1 weight part of triethanolamine salt of monostearyl phosphoric acid ester and 0.5 weight part of the colloidal silica (per 100 weight parts of the polyamic acid).

The polyamic acid solution was then extruded from a slit of T die to prepare a continuous polyamic acid solution film (thickness: 300 μm) on a surface-smooth stainless steel substrate. The solution film was heated to a temperature of 120 to 160° C. for 10 min., to give a self-supporting film, and separated from the substrate. The self-supporting film was then dried to give a dry film containing a volatile component in an amount of 27.5 wt. %.

The dry self-supporting film was gripped at both sides and introduced into a continuous heating furnace and heated up to 500° C. (maximum temperature) for proceeding with imidization. The film was heated at the maximum temperature for 0.5 min. The resulting aromatic polyimide film contained less than 0.4 wt. % of a volatile component and had a thickness of 35 μm.

The physical characteristics of the resulting poly-

Spring back value (mean value of three samples): 1.36 g

Defective spots having a maximum diameter of 50 μm or larger: 8/1 m²

Mean waviness length: 0.586 nm

Mean square root waviness length: 0.747 nm

Height of waviness: 6.661 nm

Mean roughness: 0.471 nm

Mean square root roughness: 0.604 nm

Maximum roughness: 17.0 nm

Variation of thickness (T) in width direction: Tₘₐₓ=35.4 μm, Tₘᵢₙ=34.7 μm

Coefficient of linear thermal expansion (CTE):
CTE in MD=14.5×10⁻⁶ cm/cm/° C.
CTE in TD=16.3×10⁻⁶ cm/cm/° C.

Modulus in tension (MD): 970 kgf/m²

### EXAMPLE 2

The polyimide film prepared in Example 1 was subjected to vacuum plasma processing to etch its surface in a vacuum plasma processing apparatus. In the apparatus, the polyimide film was placed, Ar gas was introduced after evacuation to 0.1 Pa, and the plasma processing was carried out under Ar gas (100%), at a pressure of 0.67 Pa, and at a power of 300 W (13.56 MHz).

The polyimide film having been subjected to the vacuum plasma processing was placed in a DC sputtering apparatus. The apparatus was evacuated to a pressure of lower than 2×10⁻⁴ Pa, and Ar gas was introduced to reach 0.67 Pa. In the apparatus, a nickel-chromium alloy film (5 nm) was deposited by DC sputtering using a target of Ni/Cr alloy (20/80, weight ratio).

Subsequently to the sputtering, a Cu metal film (thickness: 300 nm) deposited on the Ni/Cr alloy film of the polyimide film was by DC sputtering at a pressure of 0.67 Pa (Ar gas atmosphere). 0.67 Pa (Ar gas atmosphere).

On the Cu film deposited on the Ni/Cr film of the polyimide film was plated a Cu metal film (thickness: 20 μm) in an acidic copper sulfate solution by electrolytic plating. The electrolytic plating was carried out by a series of steps of alkali defatting, washing with water, washing with acid, and plating (current: 1 A/dm² for 5 min., and 8 A/dm² for 20 min.), to give a polyimide composite sheet.

The resulting polyimide composite sheet had the following physical characteristics:

initial peeling strength: 0.5 kgf/cm,

peeling strength after heat treatment (150° C., 168 hrs.): 0.2 kgf/cm, and

surface condition of the top copper film: good.

### COMPARISON EXAMPLE 2

A commercially available polyimide film for COF system had a thickness of 38 μm and contained an inorganic filler having a mean diameter of larger than 1 μm.

The physical characteristics of the polyimide film were set forth below.

Defective spots having a maximum diameter of 50 μm or larger: 31/1 m²

Mean waviness length: 15.1 nm

Mean square root waviness length: 19.2 nm

Height of waviness: 130.0 nm

Mean roughness: 50.0 nm

Mean square root roughness: 60.4 nm

Maximum roughness: 1904.7 nm

Variation of thickness (T) in width direction: Tₘₐₓ=37.9 μm, Tₘᵢₙ=37.3 μm

### EXAMPLE 3

A self-supporting polyamic acid film was prepared on a substrate in the same manner as that in Example 1. The available from Nippon Unicar Co., Ltd, in the form of 3% solution), and dried by blowing an air heated to 120° C. Thus coated film was separated from the substrate. The coated film was then heated in a heating furnace at a temperature elevating from 140° C. to 450° C., to remove the solvent. Thus, an aromatic polyimide film (thickness: 35 μm) coated with a silane coupling agent was obtained.

The physical characteristics of the resulting polyimide film were set forth below.

Spring back value (mean value of three samples): 1.23 g

Defective spots having a maximum diameter of 50 μm or larger: 8/1 m²

Mean waviness length: 0.289 nm

Mean square root waviness length: 0.340 nm

Height of waviness: 1.404 nm

Mean roughness: 0.815 nm

Mean square root roughness: 1.095 nm

Maximum roughness: 21.0 nm Variation of thickness (T) in width direction: Tₘₐₓ=35.5 μm, Tₘᵢₙ=34.8 μm

Coefficient of linear thermal expansion (CIE):
CTE in MD=12.7×10⁻⁶ cm/cm/° C.
CTE in TD=13/7×10⁻⁶ cm/cm/° C.

Modulus in tension (MD): 990 kgf/m²

### EXAMPLE 4

The procedures of Example 1 were repeated except for extruding a polyamic acid solution from a slit of T die to prepare a continuous solution film having a thickness of 290 ρm on a surface-smooth stainless steel substrate. The solution film was heated to a temperature of 120 to 160° C. for 10 min., to give a self-supporting film, and separated from the substrate. The self-supporting film was then dried to give a dry film containing a volatile component in an amount of 27.5 wt. %.

The procedures of Example 3 were repeated except for employing the above-obtained dry film to give a continuous polyimide film (thickness: 33 μm) coated with a silane coupling agent.

The physical characteristics of the resulting polyimide film were set forth below.

Spring back value (mean value of three samples): 1.01 g

Defective spots having a maximum diameter of 50 μm or larger: 8/1 m²

Mean waviness length: 0.328 nm

Mean square root waviness length: 0.383 nm

Height of waviness: 1.40 nm

Mean roughness: 0.958 nm

Mean square root roughness: 1.208 nm

Maximum roughness: 18.47 nm

Variation of thickness (T) in width direction: Tₘₐₓ=33.4 μm, Tₘᵢₙ=32.7 μm

Coefficient of linear thermal expansion (CTE):
CTE in MD=11.4×10⁻⁶ cm/cm/° C.
CTE in TD=13.0×10⁻⁶ cm/cm/° C.

Modulus in tension (MD): 990 kgf/m²

### EXAMPLE 5

The procedures of Example 2 were repeated except for replacing the polyimide film of Example 1 with the polyimide film of Example 3, to give a polyimide composite sheet having a three-layer metal film (thickness: 20 μm).

The resulting polyimide composite sheet had the following physical characteristics:

initial peeling strength: 0.8 kgf/cm,

peeling strength after heat treatment (150° C., 168 hrs.): 0.34 kgf/cm, and

surface condition of the top copper film: good.

### EXAMPLE 6

### EXAMPLE 6

The procedures of Example 2 were repeated except for replacing the polyimide film of Example 1 with the polyimide film of Example 4, to give a polyimide composite sheet having a three-layer metal film (thickness: 20 μm).

The resulting polyimide composite sheet had the following physical characteristics:

initial peeling strength: 0.98 kgf/cm,

peeling strength after heat treatment (150° C., 168 hrs.): 0.28 kgf/cm, and

surface condition of the top copper film: good.

### COMPARISON EXAMPLE 3

The procedures of Example 2 were repeated except for replacing the polyimide film of Example 1 with the commercially available polyimide film of Comparison Example 2, to give a polyimide composite sheet having a three-layer metal film (thickness: 20 μm).

The resulting polyimide composite sheet had the following physical characteristics:

surface condition of the top copper film: bad.

What is claimed is:

1. An aromatic polyimide film comprising a polyimide derived from 3,3′,4,4′-biphenyltetracarboxylic acid dianhydride and p-phenylenediamine and a powdery inorganic filler, in which the film has a thickness in the range of 25 to 35 μm and does not have protrusions of 1 μm or higher, and the filler has a mean diameter of less than 1 μm.

2. The aromatic polyimide film of claim 1, in which the polyimide is derived from 3,3′,4,4′-biphenyltetracarboxylic acid dianhydride and p-phenylenediamine in the presence of a phosphoric compound.

3. The aromatic polyimide film of claim 1, in which the thickness of the polyimide film is in the range of 30 to 35 μm.

4. The aromatic polyimide film of claim 1, in which the thickness of the film varies within 1 μm in a width direction of the film.

5. The aromatic polyimide film of claim 1, in which the thickness of the film varies within 0.7 μm in a width direction of the film.

6. The aromatic polyimide film of claim 1, in which the mean diameter of the powdery inorganic filler is in the range of 0.005 to 0.3 μm.

7. The aromatic polyimide film of claim 1, in which the powdery inorganic filler is contained in an amount of 0.1 to 3 wt. % based on the amount of the polyimide.

8. The aromatic polyimide film of claim 1, which has defective spots of not more than 15/m² on a surface thereof.

9. The aromatic polyimide film of claim 1, which has a surface coated with a silane coupling agent.

10. The aromatic polyimide film of claim 1, which has a coefficient of linear thermal expansion in the range of 10×10⁻⁶ to 17×10⁻⁶ cm/cm/° C. in each of a machine direction thereof and a transverse direction thereof, and the coefficient of linear thermal expansion in the transverse direction is larger than the coefficient of linear thermal expansion in the machine direction by not larger than 5×10⁻⁶ cm/cm/° C.

11. The aromatic polyimide film of claim 1, which has a spring back value of 1.5 g or less.

12. The aromatic polyimide film of claim 1, which has been subjected to electrical discharge processing in vacuo.

13. A polyimide composite sheet comprising an aromatic polyimide film of claim 1 and a metal layer deposited on the polyimide film, in which the metal layer comprises a copper over-coat film and a under-coat film comprising at least one metal other than copper.

14. The polyimide composite sheet of claim 13, in which the under-coat layer comprises Al, W, Fe, Ni—Cr alloy, or Mo—Ni alloy.

15. The polyimide composite sheet of claim 13, in which the polyimide film has been subjected to electrical discharge processing in vacuo.

16. A process packaging a bare chip on film, which comprises the steps of:
forming a wiring pattern on a polyimide composite sheet of claim 13; and
bonding the bare chip to the wiring pattern on the polyimide composite sheet.
